(19) United States
(12) Patent Application Publication
(10) Pub. No.: US 2006/0191004 A1
(43) Pub. Date: Aug. 24, 2006

(54) Secured one-way interconnection system

(76) Inventor: Fabien Alcouffe, Colombes (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 11/339,830

(22) Filed: Jan. 26, 2006

(30) Foreign Application Priority Data
Jan. 28, 2005 (FR) 0500893

(51) Int. Cl. G06F 15/16

(52) U.S. Cl. 726/14

(57) ABSTRACT

A secured one-way interconnection system comprises at least one system A with a security level N_{A} and one system B with a security level N_{B}, the two systems exchanging information through a physical linking means, wherein the physical linking means is equipped with an optical isolator device adapted to transmitting information from the system with the security level N_{A} to the system with the security level N_{B}.

### BACKGROUND OF THE INVENTION

1. Field of the Invention

The object of the present invention relates to a system of one-way interconnection, for example from a system A with low-level security to a system B with high-level security. The system thus guarantees that there will be no transmission (whether deliberately or not) of physical and/or logic information from B to A.

More generally, the invention can be applied in any system comprising several systems having different or similar security levels, where it is desired to restrict the transmission of information in one direction, for example from a system with a security level N−1 to a system with a security level N.

It is used for example for the interconnection of two entities A and B, such as computers, networks, different network layers, etc.

2. Description of the Prior Art

In one-way information exchanges between systems, it is necessary to enable the transfer of information from a system A to a system B, for example, while at the same time ensuring that there is no deliberate or untimely transmission of information from a system B having a high level of security to a system having a security level that is low as compared with the security level of the system A.

At present, these exchanges can be controlled in Internet IP protocol networks by a firewall. However, there are many threats related to the use of such a solution. Among these, we may cite: the entrapment of the firewall software, the take-over and modification of the filtering rules of the firewall, the entrapment of the hardware of the firewall, errors of configuration of the filtering rules, encoding errors, the exploitation of flaws or weaknesses in the software, the use of electromagnetic signals by radiation or conduction.

### SUMMARY OF THE INVENTION

The invention relates to a secured one-way interconnection system comprising at least one system A with a security level N_{A} and one system B with a security level N_{B}, the two systems exchanging information through a physical linking means, wherein the physical linking means is equipped with an optical isolator device adapted to transmitting information from the system with the security level N_{A} to the system with the security level N_{B}.

The linking means is, for example, an optical fibre equipped with one or more optical isolators.

The isolator may be a passive isolator with a constant attenuation level.

The system of the invention has especially the following advantages:
It enables one-way information transfer from the system with the lowest security level A to the system with the higher security level B and, in normal operation, prohibits the logic and/or physical transfer of information from B to A, whether this transfer is deliberate or not (being caused by the entrapment of the system B for example).
The proposed solution is passive and, in normal operation, does not require any energy source; it implements materials that are non-conductive and impervious to electromagnetic radiation.
The proposed solution is independent of the type of communications protocol used for the transfer from A to B (IP (Internet protocol), RS232, ARINC, etc.).
It offers simplicity and ease of implementation, a very high level of security and resistance to computer attacks and to design, manufacturing or encoding errors.

### BRIEF DESCRIPTION OF THE DRAWINGS

Other features and advantages of the present invention shall appear more clearly from the following description of an exemplary embodiment given by way of a non-restrictive example, along with the appended figures, of which:

FIG. 1 is a block diagram of the system according to the invention,

FIG. 2 exemplifies an architecture of the system of FIG. 1,

FIG. 3 exemplifies an application for one-way exchanges between two networks having different levels of sensitivity.

FIG. 4 shows a variant comprising several systems communicating with a system having high-level security.

FIG. 5 shows an alternative embodiment for two-way exchanges with separation of upward flows and downward flows.

### MORE DETAILED DESCRIPTION

The solution is based especially on the use of a fiber-optic strand and an optical isolator.

Any other means having characteristics that are identical or substantially identical in function to the optical fibre and to the optical isolator may be used.

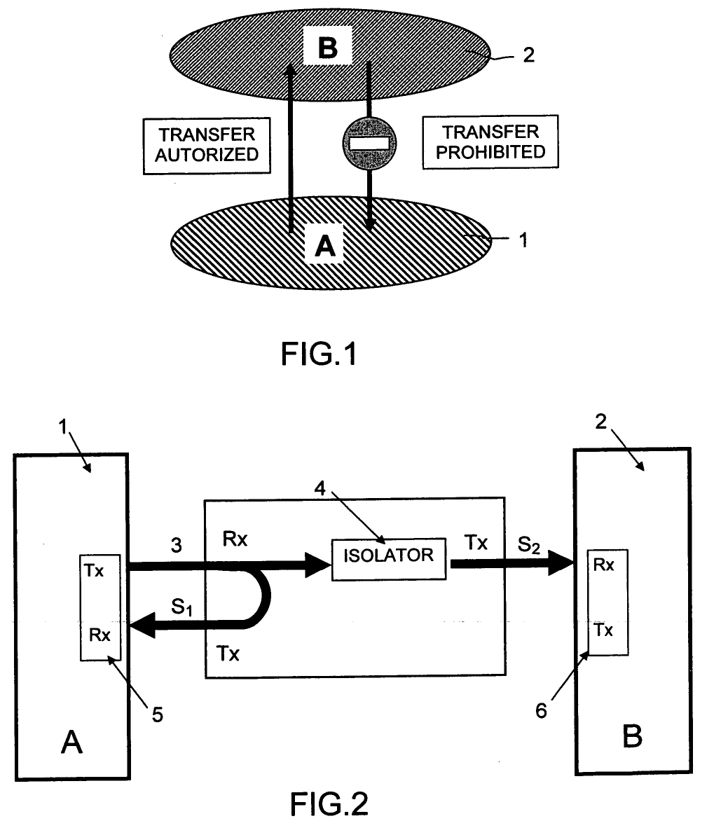

FIG. 1 represents a system A, for example a computer equipped with an optical emitter 1, and a system B, another computer equipped with an optical receiver 2. The security level of the system A is low as compared with the high level of security associated with the system B.

FIG. 2 exemplifies a secured system of one-way interconnection according to the invention, in which the systems A and B are connected by means of an optical fibre 3 equipped with an optical isolator 4.

The characteristics of the isolator are chosen, for example, to meet the requirements of compatibility with the computer A and the computer B.

The light emitted by the system A having low-level security is transmitted by the optical fibre 3. The isolator 4 is adapted so that, in normal operation, the system A is incapable of exploiting any information emitted by the system B through a connection error or because of the entrapment of the system B having high-level security. The optical isolator 4 enables especially one-way information transmission between two networks.

Since the solution is passive in normal operation, it requires no electrical power supply or any other source of energy.

The optical fibre and the optical isolator used are electrically and electromagnetically non-conductive and non-radiating.

Any malfunction in operation causes the loss of the function of transmission from A to B.

The high-intensity emission of light by the system B leads, for example, to the destruction of the isolator, thus blocking all transmission.

The isolation obtained with commercially distributed isolators is in the range of 40 dB and may be augmented by the serial connection of several isolators. The solution may be obtained with totally passive isolators having fixed attenuation levels or with isolators having adjustable attenuation levels. In the latter case, the solution requires an electrical power supply.

The system of the invention is used, for example, in the following applications: the transfer of files and messages, the replication of data bases, centralized alarm enunciation, concomitant access to information coming from different, separated systems etc.

The example given in FIG. 2 corresponds to implementation in the context of optical network cards. Each of the systems A and B is equipped with an optical network card, 5, 6. These cards generally propose automatic detection of a break in the optical fibres on the Rx connector. The cards detect the loss of reception by the optical system and put out an alarm. The Rx receiver part of the card activates an alarm if it no longer receives information coming from the Tx unit of the emitter card. This enables the detection of a problem on the transmission line constituted by the emitter, the fiber and the receiver (the signal may be a continuous carrier or a message put out at regular intervals). In the example given in this FIG. 2, a part S₁ of the emitted signal is diverted in order to be re-injected into the same card 5. This makes the system compatible with all categories of card and can be used to ascertain that the emitter is working properly.

The proposed solution uses a part S₁ of the signal T₁ sent by the system A and returns it to this system. The system A will therefore detect the light signal S₁ reaching it as if it had been sent by the system B. The rest of the signal S₂ goes through the isolator 4 before it is transmitted to the system B. This assembly has the advantage in particular of enabling the detection of a sending malfunction in the system A, this system A receiving a part of the light.

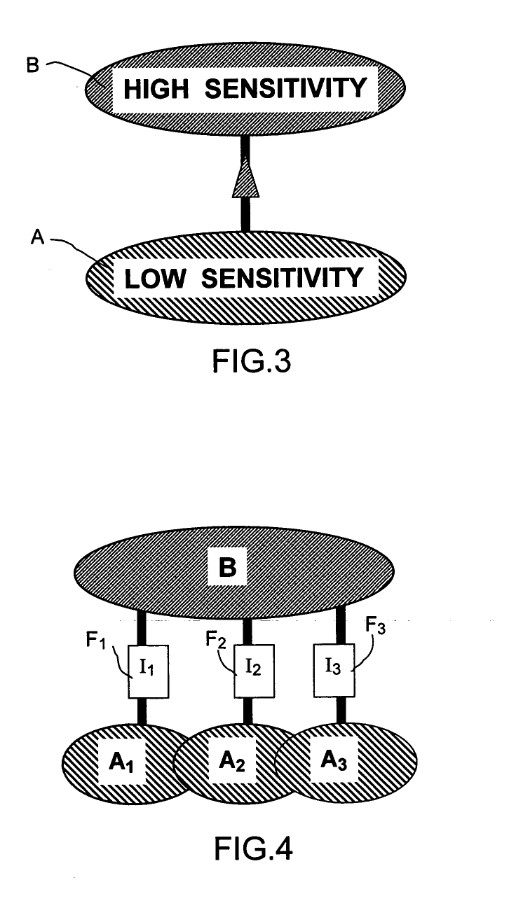

FIG. 3 gives a schematic view of another example of implementation in the context of one-way exchanges between two networks having different levels of sensitivity. The solution ensures that no information on the most sensitive network, namely the system B, can be accessed from the less sensitive system, namely the system A. Such a configuration can be applied for example to the saving of information, the duplication of databases, video streams.

FIG. 4 shows another alternative embodiment implemented in the context of the concentration in a system B of information coming from different systems An, each of these systems having a lower security level than that of the system B.

For this purpose, each optical fibre Fi linking a system Ai and the system B is equipped with an optical isolator li having functional characteristics that are identical or substantially identical to those described with reference to FIG. 2.

The solution ensures that no information from the system B is accessible from the systems An and between the different systems An. The invention can be applied especially to the saving of information, the concentration of log-in information and data fusion.

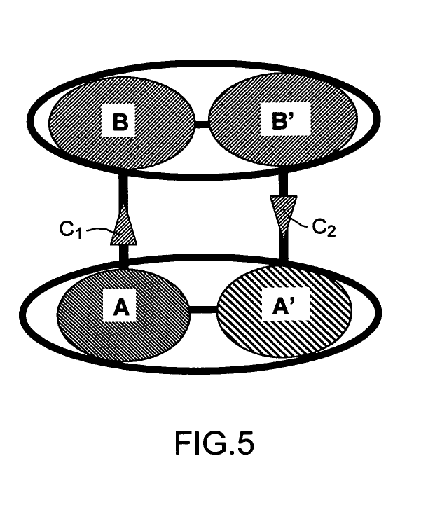

FIG. 5 provides a schematic view of the solution that can be implemented in the context of the two-way exchanges with separation of uplink and downlink streams.

This solution enables the transmission of information from B to A, for example a functional acknowledgement following the transmission of a piece of information from A to B via a channel C₁ equipped with an optical isolator as described here above. The transmission from B to A is done via a channel different from that of transmission from A to B. This other one-way channel C₂ makes information travel from B to a similar device B′ which sends the information back to a device A, for example by means of an optical fibre equipped with an isolator that is not shown. The information is then transmitted to the device A.

This alternative embodiment takes account of the threats belonging to the type in which the topology of the system B is analysed from the system A by scanning, namely protocol type attacks. This approach enables solutions of independent filtering in both directions, of flow the associated threats being different. In this example, acknowledgments at the communications protocol level are not always possible since the communications channel is a one-way channel. However, another one-way channel enables a so-called “functional” acknowledgement (for example the sending of piece of information on reception of a message).

1. A secured one-way interconnection systems comprising:
a first system with a security level N_{A} and a second system with a security level N_{B}, the two systems exchanging information through a physical linking means,
wherein the physical linking means is equipped with an optical isolator device adapted to transmitting information from the first system with the security level N_{A} to the second system with the security level N_{B}.

2. The system according to claim 1, wherein the security level N_{A} is lower than the security level N_{B}.

3. The system according to claim 1, wherein the linking means is an optical fiber equipped with one or more optical isolators.

4. The system according to claim 1, wherein the isolator is a passive isolator with a constant attenuation level.

5. The system according to claim 1, wherein the isolator has a variable attenuation level.

6. The system according to claim 3, wherein each system and is equipped with an optical network card and means for the automatic detection of a fiber break.

7. The system according to claim 1, comprising several systems with security levels lower than that of the second system, each system and communicating with the system by a physical link wherein each physical link is equipped with an isolator.
